(19) United States
(12) Patent Application Publication
(10) Pub. No.: US 2009/0327272 A1
(43) Pub. Date: Dec. 31, 2009

(54) Method and System for Searching Multiple Data Types

(76) Inventor: Rami Koivunen, Turku (FI)

Correspondence Address: DITTHAVONG MORI & STEINER, P.C., 918 Prince St., Alexandria, VA, 22314, US

(21) Appl. No.: 12/164,851

(22) Filed: Jun. 30, 2008

(51) Int. Cl. G06F 17/30

(52) U.S. Cl. 707/5; 707/E17.017

(57) ABSTRACT

A method may include receiving data. A format of the data may be detected. Search parameters may be extracted from the data based on the format of the data. The search parameters may be extracted in a manner dependant upon the detected format of the data. The search parameters may be compared to index parameters. Search results based on the comparison of the search parameters to the index parameters may be output.

### BACKGROUND

1. Field of Invention

Example embodiments relate to information retrieval systems, and for example, to an information retrieval system supporting multiple different data types as search parameters.

2. Background

Conventional Internet search engines provide a search bar for receiving an input text string. The search engine searches for items related to the inputted text. For example, if a user wants to search for a person appearing in a picture, the user would need to know something about the person to input a text string into the search bar in order to find related information. Therefore, the search will be unavailable if the user is unable to provide textual information describing the person.

Similarly, a user who is listening to music and would like to find information related to the music would be unable to search for the information if inputted text utilized to identify the desired music is not adequately descriptive. Further, a user watching video would also be unable to use conventional search engines if textual identification information is not provided with the video.

A user may also desire to obtain information related to a geographical location. However, the user would be required to input coordinates in a specific format to a specific search engine window in order to use a conventional search engine.

### SUMMARY

Example embodiments may provide a method, apparatus and/or computer program product supporting multiple different data types as search parameters.

According to an example embodiment, a method may include receiving data. A format of the data may be detected, and search parameters may be extracted from the data based on the format of the data. The search parameters may be extracted in a manner dependent upon the detected format of the data. The search parameters may be compared to index parameters, and search results based on the comparison of the search parameters to the index parameters may be output.

According to another example embodiment, an apparatus may include an input component, a file analyzer, and/or a search component. The input component may be configured to receive data. The file analyzer may be configured to detect a format of the data and extract search parameters from the data based on the format of the data. The file analyzer may be configured to extract the search parameters in a manner dependent upon the detected format of the data. The search component may be configured to compare the search parameters to index parameters and output search results based on the comparison of the search parameters to the index parameters.

According to still another example embodiment, a computer program product may include a computer usable medium having computer readable program code embodied in said medium for managing information available via a wireless connection. The product may include a computer readable program code for receiving data, a computer readable program code for detecting a format of the data, a computer readable program code for extracting search parameters from the data based on the format of the data, the search parameters extracted in a manner dependent upon the detected format of the data, a computer readable program code for comparing the search parameters to index parameters, and/or a computer readable program code for outputting search results based on the comparison of the search parameters to the index parameters

### DESCRIPTION OF DRAWINGS

Example embodiments will be further understood from the following detailed description of various embodiments taken in conjunction with appended drawings, in which:

FIG. 1 illustrates components of a search engine according to an example embodiment;

FIG. 2 is a flow chart illustrating a method of searching according to an example embodiment;

FIG. 3 illustrates an example graphical user interface (GUI) and system processing flow according to an example embodiment; and

FIG. 4 illustrates an example use scenario for a search engine according to an example embodiment.

### DESCRIPTION OF EXAMPLE EMBODIMENTS

Reference will now be made to example embodiments, which are illustrated in the accompanying drawings, wherein like reference numerals refer to the like components throughout.

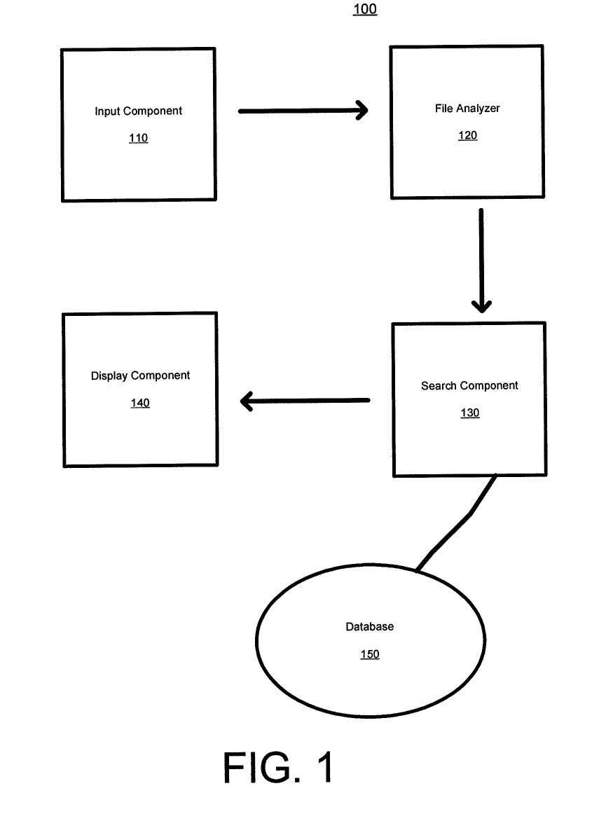

FIG. 1 illustrates components of a search engine according to an example embodiment. A search engine 100 may include an input component 110, a file analyzer 120, a search component 130, a display component 140, and/or a database 150. The database 150 may be included in the search engine 100, or may be an externally located database (or databases) accessible to the search engine 100.

The search engine 100 and methods and processes thereof may be implemented by a computer network system. The computer network system may include a server configured to control hardware and/or software for implementing the search engine and/or user terminals connected, (e.g., through the Internet or an intranet), to the server for accessing the search engine 100. The server may include a processor configured to execute instructions on a computer readable medium. The server may receive input data and perform search engine functions.

According to another example embodiment a user terminal may detect the format of the data, perform the extraction of search parameters, and send the extracted search parameters to the server for searching to save server resources. The extracted search parameters may be sent to the server by various electronic methods, (e.g., short message service (SMS), multimedia messaging service (MMS), email, instant message, or other messaging technology). According to still another example embodiment, the search engine 100 may be in the user terminal and processing for each of the components of the search engine may be performed in the user terminal. As such, no network server or connection thereto may be needed. However, example embodiments are not limited thereto, and the search engine 100 may be implemented by a user accessing the Internet, a computer network system, or wireless telecommunications network with personal computer, a mobile phone, or other computing device in order to utilize the search engine 100. In at least one example use scenario, a user may take a picture of an object and press a “search” button on a mobile phone to perform a search based on the image. The search engine 100 may return search results related to the picture.

The user terminal may be in a wireless communication network, (e.g., WLAN, 3G/GPRS communications network, or other connection to the Internet or an intranet), or alternatively, the user terminal may be connected to the Internet or an intranet via a wired communications network. The user terminal may access the search engine 100 through the wired or wireless communications network. For example, the wireless communications network may include a plurality of user terminals connected to a plurality of base transceiver stations and/or a radio network controller. The user terminal may include a display, a memory, and/or a microprocessor device. The display may be a conventional display or a touch screen display. A user may input data to the user terminal through touching the touch screen display. The user may input data to the user terminal through another input device, (e.g., a stylus, a joystick, a navi-key, a roller, a keypad etc.), or from memory or a computer program product stored in the user terminal. According to an example use scenario, if a user has a touch screen and the user finds an item to be searched, the user may receive a look up table to view and select a number of alternative options, (e.g. search, etc). If the user selects the search option, the user may make a circle, box, or other “cut out” in the picture to select a portion of the picture to be searched. Alternatively, the search option may be selected after the circle, box, etc. is drawn to select the portion of the item to be searched.

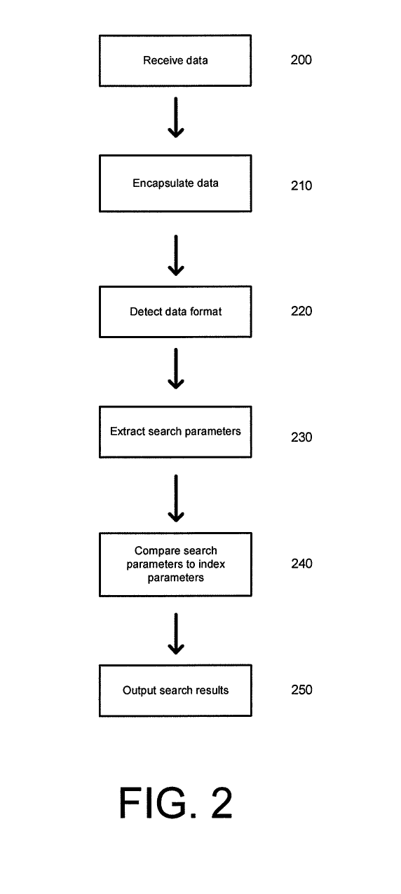

Referring to FIGS. 1-2, the input component 110 may receive data from a user and/or a computer system at step 200. The input component 110 may receive the data through a search tool. The input component 110 may provide a search window, (e.g., as the search tool), as a graphical user interface (GUI) with which the user may input the data.

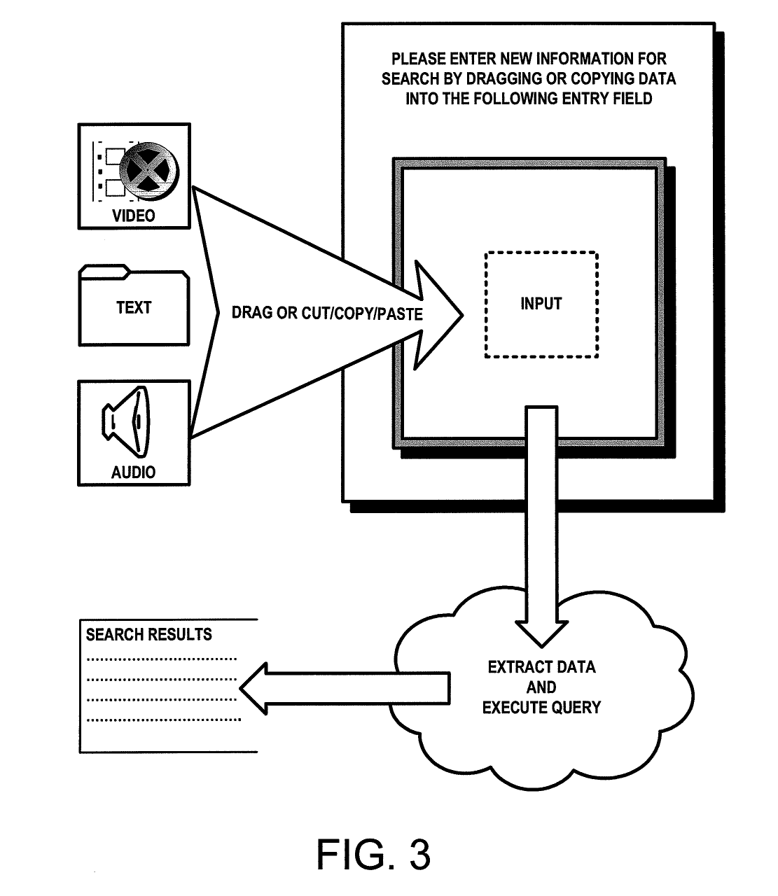

FIG. 3 illustrates an example GUI and system processing flow according to an example embodiment. However, example embodiments are not limited thereto, and the input component 110 may receive data by means other than the search window (e.g., through import functions and other data access procedures). For example, according to an example use scenario, a user may view a picture of people in an electronic newspaper. The user may cut and paste a face of a person to the search window. The search engine 100 may return with a catalog of pictures of the person and information related to the person and/or the pictures. Alternatively, the user may read a web page having a picture of a person. The user may cut and paste the portion of the web page, (e.g. the image of the person) to the search window, and the search engine 100 may search for information on the person. If metadata is attached to the image, the metadata may be searched and a result provided based on the metadata. The search window may be on the web page so that the drag and drop may be performed more easily by the user. Alternatively, the search window may be transparently visible on the web page so that user may more easily drag and drop the data to be searched to the search window.

In accordance with an example embodiment, various types of data may be used to search including, for example, video data, audio data, image data, text data, and/or metadata. The data may be included in one or more files. The data may be a portion of data cut or copied from a file. As illustrated in FIG. 3, the data may be “dragged and dropped” into a search window, “cut/copy and pasted” into the search window, typed into the search window, or received directly via a microphone, scanner, an open, (e.g., browsed), file, or other data input source. A user may drag a file icon or other representation of the file into the search window within the GUI to input the data to the search engine. For example, a user may drag and drop an image from the Internet into the search window and utter a word into a microphone (or alternatively enter the word as text), and the input component 110 may receive both the image data and the word as audio data or text data. For example, according to another example use scenario, a user may watch a video of the Winter Olympics from year the 1980. The user may gap a piece of video and drop the gapped video to the search bar. The search engine 100 may return with statistics from the Olympic game in the video and/or additional videos of other Olympic games.

Alternatively, the user may perform a cut/copy and paste function to paste data, (e.g., a face of a person from an image), into the search window. If the user is searching global positioning system (GPS) coordinates or a map location, the user may drag and drop a coordinate item related to a location in the search window. For example, according to an example use scenario, a user may check GPS coordinates and/or a map location. The user may drag and drop a coordinate item to the search window and information related to the position represented by the coordinate item is returned. In another example embodiment, for example, in a mobile phone, pressing and holding menu key a desired, or alternatively, a predetermined time, (e.g. in Nokia E61i), may enable the user to see currently running applications in a list of the current applications. The user may switch between applications such that the user may more easily copy the part of searchable data, (e.g., the GPS coordinates) and drop the data on another running application, (e.g., the search tool), and see search results returned by the search engine 100.

Text may be included with other data, (e.g., video, audio, or image data) to provide keywords to guide a search based on the other data. For example, a user may provide keywords with an image to guide a search based on the image. For example, according to another example use scenario, a user may drag and drop a portion of a picture, (e.g., a portion of a picture that has been cut and pasted), to the search window and provide textual key words to guide a search. The search engine 100 may return search results related to the portion of the picture, the search results narrowed down with matching parameters for the provided keywords. Accordingly, a sequential search providing a more narrow search result through additional parameters input to the search tool may be employed by the user.

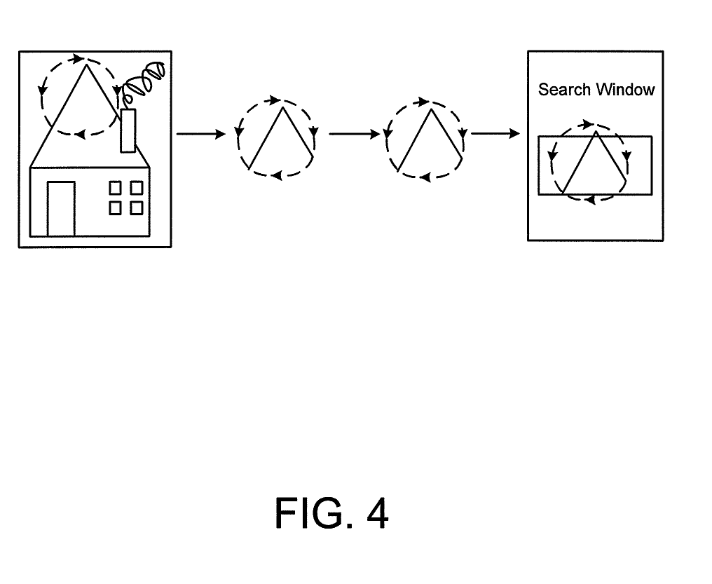

FIG. 4 illustrates an example use scenario for a search engine 100 according to an example embodiment. A user may select an area of an image, for example, the user may make a closed circle, box, etc with their finger if using a touch screen device, or with a mouse if using a conventional display to select a portion of the image as illustrated in FIG. 4. Accordingly, the user device may recognize that the user has selected an area of the image. The user may press twice in the selected area, either with a finger or a button on a mouse, and start to move the selected area with the finger or the mouse still depressed to drop the selected area in the search window. FIG. 4 illustrates an example user selection of a portion of an image, the selected portion of the image being dragged toward the search window, and the selected portion of the image being dropped into the search window to input the selected portion of the image to the search engine 100. If a user lifts the finger from the screen or releases the button on the mouse before the selected portion of the image is input to the search window, the selected portion of the image may remain on the screen at the released position. However, if the user lifts the finger or releases the mouse button if the selected portion of the image is over the search window, the image may be input to the search engine 100 and the image on the display may vanish. Alternatively, the search window may continue to display the image or a representation of the image, (e.g., an icon or textual note), to provide the user with a reminder of the items entered for search. In another example use scenario, an image or portion thereof may be selected and input to the search engine 100 by pressing a button on a user device or pressing a soft key on a display screen of the user device after the area to be searched is determined by drawing the closed circle, box, etc.

Referring again to FIGS. 1-3, at step 210, the input component 110 may wrap the input data in a metadata container, (e.g., using extensible markup language (XML)), and send the data to the file analyzer 120. At step 220, the file analyzer 120 may detect a format of the data, (e.g., video data, audio data, image data, text data, metadata, etc., or for example, tiff, gif, txt, doc, xls, mpeg, etc.), and extract search parameters related to the data at step 230. Although FIG. 1 illustrates the file analyzer 120 as included in the search engine 100, the file analyzer may be externally located in a terminal of the user so that a server running the search engine 100 need not bear the processing load required to extract the search parameters. A parameter extraction process may, for example, be loaded from the server to the terminal of the user. Accordingly, if the extraction method is updated the terminal of the user may perform a more up to date extraction process.

The file analyzer 120 may apply an extraction process to the data based on the format of the data and apply format specific filtering for different types of input data. If different portions of the data have different formats, (e.g., image data and audio data were received at the same time for the same search), the file analyzer 120 may apply different extraction processes and filtering for the portions of the data having different formats. For example, as noted above, a user may input image data and audio data to the search window so that the image data and audio data may be searched together. Accordingly, the file analyzer 120 may apply different extraction processes tailored to retrieve different data structures and features from the image data as compared to the audio data.

The file analyzer 120 may apply an extraction process to data based on an extraction process for other data. The file analyzer 120 may extract search parameters from the data based on search parameters extracted from the other data. Accordingly, the search parameters (and search results) for the data may be based on a dependency between multiple data input to be searched and the format of the individual data types. For example, if a user inputs the text string “I want to know where this guy bought these eye glasses” and an image of a person with eye glasses, the file analyzer 120 may extract search parameters corresponding to the “eye glasses” portion of the image based on the text string containing information about “eye glasses.” The dependency between the multiple data may be determined by a user such that the user may determine for which data the extraction process thereof should be affected by the search parameters extracted from other data. Extraction processes for two or more different data may be iteratively repeated based on search parameters extracted from a previous iteration of the extraction processes of each other. Accordingly, the search parameters for each data may be iteratively refined by an extraction process.

The extracted search parameters may include, for example, text strings and/or more complex data structures, (e.g., a 3D object, a contour of a face, image features, patterns in music, etc). The extracted search parameters may be whatever features of the input data are used by the search engine 100 to match different types of data. For example, if images are compared, the extracted search parameters may be a desired, or alternatively, a predetermined format for describing and searching images. Alternatively, if a user drags and drops a multimedia and/or metadata container file to the search window. The search engine 100 may output search results search relevant to the metadata file after extracting search parameters based on the metadata.

The file analyzer 120 may use various methods for extracting the search parameters from the data. Example embodiments may use any number of data or feature extraction processes to extract the search parameters. For example, the feature extraction processes may incorporate one or more various methods to extract text from an image or video, objects from an image or video, musical notes or portions of audio tracks and/or patterns thereof, metadata from files, portions of images and video sequences, etc. For example, according to another example use scenario, a user may listen to MP3 audio with a user device. The user may drag and drop the .mp3 file for the audio to the search window. The search window recognizes that the file is an MP3. The user device may establish connection with a server after the file is received if the search engine 100 is not included in the user device. The server interrogates a database to identify the musical piece, for example, by comparing the sound of the received musical piece or portions of the received musical piece with sounds recorded in the database. For a vocal piece, a voice recognition system may be utilized. The search engine 100 searches for information related to the content of the MP3, (e.g., song writer, or if the MP3 is a speech the speaker, documents, etc.). The search results may be displayed to the user in a list. According to another example embodiment, the search engine 100 may be coupled to and/or interfaced with the user device, (e.g. a mp3 player), so that the search engine 100 knows that the user is playing a MP3, and therefore, the search engine 100 may know that a search request is related to audio or more specifically an MP3. Accordingly, the search engine may narrow the scope of possible searchable matters and speed up the search result. According to another example use scenario, a user may listen to an audio book. The user may cut and paste a piece of the audio track to the search window. The search engine may search related documents, audio tracks, videos, etc. which are related to the content of the audio track, for example, as described above in the example use scenario for an MP3.

At step 240, the search component 130 may compare the search parameters with index parameters stored in the database 150. A searching process of the search component 130 may be guided, (e.g., narrowed), by key words provided in addition to other data received in the search window. For example, an image of a flower and the textual key word “drapes” may be received, and the search engine 100 may compare search parameters to return a list of links that point to drapes which have a picture similar to that of the image of the flower and/or a list of places where the drapes may be bought, etc. As noted above, the search parameters need not be limited to text. Accordingly, the index parameters may have features and data structures corresponding to the search parameters, (e.g., image features, patterns in music, 3D objects, etc).

As noted above, the input component 110 may receive data including multiple different format types. The search component 130 according to example embodiments may compare and search with search parameters based on the data having different format types. For example, a search may be performed based on input data including an audio file, (e.g., an MP3 file) and an image file, (e.g., picture of an song writer). Accordingly, input data including data having two or more different formats may be received, extracted, and searched together. The search parameters for different data types may be compared in conjunction such that the search results returned are related to or influenced by the search parameters for each of the different data types. For example, as noted above, an extraction process for search parameters for first data may be influenced by the search parameters extracted for other data and/or both the search parameters for the first data and the other data may be used together in a search by the search component 130.

At step 250, the search component 130 may output the results of the comparison as search results, for example, video, image, text, and/or objects which are determined by the search component 130 to be sufficiently related to the search parameters. The display component 140 may display the search results. The search results may be organized in accordance with various presentation formats and may include the related files and/or links thereto organized in a desired, or alternatively, a predetermined manner.

Although example embodiments have been shown and described in this specification and figures, it would be appreciated by those skilled in the art that changes may be made to the illustrated and/or described example embodiments without departing from their principles and spirit.

What is claimed is:

1. A method, comprising:
receiving data;
detecting a format of the data;
extracting search parameters from the data based on the format of the data, the search parameters being extracted in a manner dependant upon the detected format of the data;
comparing the search parameters to index parameters; and
outputting search results based on the comparison of the search parameters to the index parameters.

2. The method of claim 1, further comprising:
wrapping the data in a metadata container.

3. The method of claim 1, wherein the data comprises at least one of video data, audio data, image data, and metadata.

4. The method of claim 1, wherein
receiving the data includes receiving data having at least two different formats, and
the data comprises two or more of video data, audio data, image data, metadata, and text data.

5. The method of claim 4, wherein
extracting the search parameters includes extracting the search parameters for data having a first format of the at least two different formats in a different manner from data having a second format of the at least two different formats, and
at least some of the search parameters for the data having the first format have a different data structure type than at least some of the search parameters for the data having the second format.

6. The method of claim 5, wherein
extracting the search parameters includes extracting the search parameters for one of the data having the first format and the data having the second format based on the search parameters extracted for the other of the data having the first format and the data having the second format, and
the search results are based on comparing the search parameters for the data having the first format to the index parameters in conjunction with comparing the search parameters for the data having the second format to the index parameters.

7. The method of claim 1, wherein receiving the data includes receiving the data via a search window provided to a user through a graphical user interface.

8. The method of claim 7, wherein the data is a file that has been dragged and dropped into the search window.

9. The method of claim 7, wherein the data is inputted into the search window through at least one of a copy-and-paste function or a cut-and-paste function.

10. The method of claim 1, wherein extracting the search parameters from the data based on the format of the data is performed by an external device.

11. The method of claim 1, wherein the index parameters are stored in a database, and at least some of the index parameters are data structures other than text data.

12. An apparatus, comprising:
an input component configured to receive data;
a file analyzer configured to detect a format of the data and extract search parameters from the data based on the format of the data, the file analyzer configured to extract the search parameters in a manner dependant upon the detected format of the data; and
a search component configured to compare the search parameters to index parameters and output search results based on the comparison of the search parameters to the index parameters.

13. The apparatus of claim 12, wherein the input component is configured to wrap the data in a metadata container.

14. The apparatus of claim 12, wherein the data comprises at least one of video data, audio data, image data, and metadata.

15. The apparatus of claim 12, wherein
the input component is configured to receive data having at least two different formats, and
the data comprises two or more of video data, audio data, image data, metadata, and text data.

16. The apparatus of claim 15, wherein
the file analyzer is configured to extract the search parameters for data having a first format of the at least two different formats in a different manner from data having a second format of the at least two different formats, and
at least some of the search parameters for the data having the first format have a different data structure type than at least some of the search parameters for the data having the second format.

17. The apparatus of claim 16, wherein
the file analyzer is configured to extract the search parameters for one of the data having the first format and the data having the second format based on the search parameters extracted for the other of the data having the first format and the data having the second format, and
the search results are based on comparing the search parameters for the data having the first format to the index parameters in conjunction with comparing the search parameters for the data having the second format to the index parameters.

18. The apparatus of claim 12, wherein the input component is configured to receive the data via a search window provided to a user through a graphical user interface.

19. The apparatus of claim 18, wherein the data is a file that has been dragged and dropped into the search window.

20. The apparatus of claim 18, wherein the data is inputted into the search window through at least one of a copy-and-paste function or a cut-and-paste function.

21. The apparatus of claim 12, wherein the file analyzer is an external device.

22. The apparatus of claim 12, further comprising:
a database configured to store the index parameters, wherein at least some of the index parameters are data structures other than text data.

23. A computer program product comprising a computer usable medium having computer readable program code embodied in said medium for managing information available via a wireless connection, said product comprising:
a computer readable program code configured to receive data;
a computer readable program code configured to detect a format of the data;
a computer readable program code configured to extract search parameters from the data based on the format of the data, the search parameters being extracted in a manner dependant upon the detected format of the data;
a computer readable program code configured to compare the search parameters to index parameters; and
a computer readable program code configured to output search results based on the comparison of the search parameters to the index parameters.

24. The computer program product of claim 23, further comprising:
a computer readable program code configured to wrap the data in a metadata container.

25. The computer program product of claim 23, wherein the data comprises at least one of video data, audio data, image data, and metadata.

26. The computer program product of claim 23, wherein
the computer readable program code configured to receive the data is configured to receive data having at least two different formats, and
the data comprises two or more of video data, audio data, image data, metadata, and text data.

27. The computer program product of claim 26, wherein
the computer readable program code configured to extract the search parameters is configured to extract the search parameters for data having a first format of the at least two different formats in a different manner from data having a second format of the at least two different formats, and
at least some of the search parameters for the data having the first format have a different data structure type than at least some of the search parameters for the data having the second format.

28. The computer program product of claim 27, wherein
the computer readable program code configured to extract the search parameters is configured to extract the search parameters for one of the data having the first format and the data having the second format based on search parameters extracted for the other of the data having the first format and the data having the second format, and
the search results are based on comparing the search parameters for the data having the first format to the index parameters in conjunction with comparing the search parameters for the data having the second format to the index parameters.

29. The computer program product of claim 23, wherein the computer readable program code configured to receive the data is configured to receive the data via a search window provided to a user through a graphical user interface.

30. The computer program product of claim 29, wherein the data is a file that has been dragged and dropped into the search window.

31. The computer program product of claim 29, wherein the data is inputted into the search window through at least one of a copy-and-paste function or a cut-and-paste function.

32. The computer program product of claim 23, wherein the computer readable program code configured to extract the search parameters from the data based on the format of the data is included in an external device.

33. The computer program product of claim 23, wherein the index parameters are stored in a database, and at least a portion of the index parameters are data structures other than text data.

34. An apparatus, comprising:
means for receiving data;
means for detecting a format of the data;
means for extracting search parameters from the data based on the format of the data, the search parameters being extracted in a manner dependant upon the detected format of the data;
means for comparing the search parameters to index parameters; and
means for outputting search results based on the comparison of the search parameters to the index parameters.

35. A system, comprising:
an input component;
a file analyzer;
a search component;
the input component configured to receive data;
the file analyzer configured to detect a format of the data and extract search parameters from the data based on the format of the data, the file analyzer configured to extract the search parameters in a manner dependent upon the detected format of the data;
the search component configured to compare the search parameters to index parameters and output search results based on the comparison of the search parameters to the index parameters.
